(19) United States
(12) Patent Application Publication
(10) Pub. No.: US 2009/0046713 A1
(43) Pub. Date: Feb. 19, 2009

(54) METHOD AND APPARATUS FOR TRANSMITTING NON-DECODABLE PACKETS

(75) Inventors: Edward Harrison Teague, San Diego, CA (US); Avneesh Agrawal, San Diego, CA (US); Aamod Khandekar, San Diego, CA (US); Alexei Gorokhov, San Diego, CA (US)

Correspondence Address: QUALCOMM INCORPORATED, 5775 MOREHOUSE DR., SAN DIEGO, CA, 92121, US

(73) Assignee: QUALCOMM, INCORPORATED, San Diego, CA (US)

(21) Appl. No.: 12/188,851

(22) Filed: Aug. 8, 2008

Related U.S. Application Data
(60) Provisional application No. 60/956,251, filed on Aug. 16, 2007.

(51) Int. Cl. H04L 12/56

(52) U.S. Cl. 370/389

(57) ABSTRACT

Acknowledgments (ACKs/NACKs) are suppressed when transmitting non-decodable packets in a communication system that utilizes HARQ. Non-decodable packets are transmitted to save system bandwidth and make the overall spectral efficiency higher. The transmitter and receiver know that in HARQ when the transmitter transmits a non-decodable packet to the receiver, this will cause the receiver to automatically transmit back a NACK. The transmitter and receiver exploit this fact by discarding and/or not transmitting the NACK (respectively).

### CLAIM OF PRIORITY 35 U.S.C. §119

The present Application for Patent claims priority to Provisional Application No. 60/956,251 entitled “ACKNOWLEDGEMENT SUPPRESSION IN HARQ WITH NON-DECODABLE PACKETS” filed Aug. 16, 2007, and assigned to the assignee hereof and hereby expressly incorporated by reference herein.

### BACKGROUND

1. Field

The disclosed aspects relate generally to communication systems that transmit non-decodable packets, and more specifically to systems that transmit non-decodable packets while employing Hybrid Automatic Repeat Request (HARQ).

2. Background

The Automatic Repeat Request (ARQ) protocol is used in many communication systems. ARQ is a method for increasing the reliability of a communication system by requesting the retransmissions of information, typically packets, which were received in error. ARQ makes use of acknowledgments (ACKs) to achieve reliable data transmission. An acknowledgment (ACK) is a message sent by the receiver to the transmitter to indicate that it has correctly received the data. Typically, when the transmitter does not receive an ACK within a time limit, it retransmits the information. The transmitter continues to retransmit the information until the information is correctly received and the receiver sends the transmitter an ACK, or until a predetermined number of retransmissions is exceeded. Receivers can also request a retransmission in the form of a negative ACK (NACK). A NACK informs the transmitter that a packet was unsuccessfully received. There are many variations of ARQ known and used in the art.

Hybrid Automatic Repeat Request (HARQ) is a variation of ARQ. HARQ typically, provides better performance than ordinary ARQ, at the cost of increased implementation complexity. HARQ typically has a target number of retransmissions and uses some type of Forward Error Correction (FEC) encoding. There are several variations of HARQ known and used in the art. However, most of the versions fall under two main categories: Chase Combining and Incremental Redundancy.

One version of HARQ is called Type I HARQ. Type I HARQ simply combines forward error correction (FEC) with ARQ. Basically, the data block is encoded with an FEC prior to transmission. When the encoded data block is received, the receiver first decodes the error-correction code. If the receiver detects that errors are uncorrectable using the FEC, then a retransmission is requested by the receiver. The transmitter then resends the same information or packet. The receiver typically soft combines the retransmissions to decode the packet. The resending of the same information or packet is typically called Chase Combining (CC) retransmission.

Another version of HARQ is Type II/III HARQ. Type II/III HARQ is an incremental redundancy (IR) HARQ. Basically, different retransmissions are encoded differently, which gives better performance since coding is effectively done across retransmissions. The main difference between type II HARQ and type III HARQ is that the retransmission packets in Type III HARQ can be decoded by themselves.

An example of incremental redundancy type II HARQ is used in High Speed Downlink Packet Access (HSDPA) as defined in the 3GPP standard. The data block is first coded typically with a Turbo 1/3 rate code, then during each retransmission the coded block is usually punctured (interleaved); only a fraction of the coded bits are chosen and sent. The punctuation pattern used during each retransmission is different, so different coded bits are sent each time. Rather than discarding the non-decodable packets, packets are saved and used in conjunction with the retransmitted packets to increase the chances of decoding the packets. HSDPA typically uses a Stop-And-Wait (SAW) protocol for the HARQ wherein the transmitter waits for an ACK from the receiver before transmitting the next packet or block of information. The number of retransmissions is also typically set to a target number. Although HARQ schemes are useful and provide reliability of data in communication systems, there are problems associated with them.

One of the problems encountered with HARQ is that the overall system efficiency may be reduced because of the increased overhead when sending ACK/NACK messages.

Another problem is that, in general, when more packets are transmitted in order to properly decode the packets, there could be more delays in decoding the packets.

Also, ACK/NACK detection errors can occur at the transmitter resulting in serious transmission problems for the communication system. Primarily because the ACK/NACK indication is typically a single bit and thus more prone to errors.

Moreover, increasing HARQ transmissions may result in less spectral efficiency.

All of these problems are undesirable in a high speed limited resource communication system. Therefore, there is a need in the art to provide solutions to the above identified problems.

### SUMMARY

The various aspects disclosed herein are directed to a method and an apparatus for transmitting and receiving non-decodable packets.

In some aspects, a method is provided in which when a non-decodable packet is received, and the transmission of an acknowledgment of the received non-decodable packet is suppressed.

In some aspects, a method is provided in which when a non-decodable packet is transmitted, and the acknowledgment of the transmitted non-decodable packet is suppressed.

In some aspects, a computer-readable medium comprising code for causing a computer to perform a method in which a receiver is informed via information sent on a control channel of a non-decodable packet transmission mode, a non-decodable packet is received, and in response to the non-decodable packet transmission mode the transmission of an acknowledgment of the received non-decodable packet is disabled.

In some aspects, a computer-readable medium comprising code for causing a computer to perform a method in which information is sent on a control channel that informs a receiver of a non-decodable packet transmission mode, a non-decodable packet is transmitted, and an acknowledgment of the transmitted non-decodable packet is discarded.

In some aspects, an apparatus is provided in which an assignment module enables the apparatus to receive on a control channel information that informs the apparatus of a non-decodable packet communication mode, a data receiving module that enables the apparatus to receive a non-decodable packet, and an acknowledgement encoding module that enables the apparatus to suppress the transmission of a NACK for the received non-decodable packet based upon the non-decodable packet communication mode.

In some aspects, an apparatus is provided in which a scheduler module enables the apparatus to transmit on a control channel information that informs a receiver of a non-decodable packet communication mode, a data transmitting module that enables the apparatus to transmit a non-decodable packet, and an acknowledgement decoding module that enables the apparatus to discard a NACK for the transmitted non-decodable packet.

In some aspects, an integrated circuit is provided in which a processor is operable to receive on control channel information that informs a receiver of a non-decodable packet transmission mode, to receive a non-decodable packet, and disable the transmission of an acknowledgment of the received non-decodable packet in response to the non-decodable packet transmission mode. The processor also has a memory associated with it.

In some aspects, an integrated circuit is provided in which a processor is operable to transmit on control channel information that informs a receiver of a non-decodable packet transmission mode, to transmit a non-decodable packet, and to discard an acknowledgment of the transmitted non-decodable packet. The processor also has a memory associated with it.

In an aspect, means for transmitting a non-decodable packet, and means for suppressing an acknowledgment of the transmitted non-decodable packet are described.

In yet another aspect, means for receiving a non-decodable packet, and means for disabling the transmission of an acknowledgment of the received non-decodable packet are described.

Other benefits, features and advantages of the various aspects will become apparent from the following detailed description, figures and claims. It should be understood, however, that the detailed description and the specific examples, are given by way of illustration only, since various changes and modifications within the spirit and scope of the invention will become apparent to those skilled in the art from this detailed description.

### BRIEF DESCRIPTION OF THE DRAWINGS

FIG. 1 shows an exemplary high level diagram of a typical wireless communications system that may be used to operate the various aspects disclosed;

FIG. 2 shows a block diagram of a transmitter and receiver using HARQ;

FIG. 3 shows a comparison of HARQ retransmissions that use larger sized sub-blocks and smaller sized sub-blocks;

FIG. 4 shows a block diagram of a transmitter and receiver utilizing HARQ with an aspect of the disclosure;

FIG. 5 shows a method flow chart for a receiver using HARQ with an aspect of the disclosure;

FIG. 6 shows a method flow chart for a transmitter using HARQ with an aspect of the disclosure.

### DETAILED DESCRIPTION

Various aspects of the disclosure are described below. Any aspect described herein as “exemplary” is not necessarily to be construed as preferred or advantageous over other aspects. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

The various aspects disclose a method and an apparatus for suppressing an acknowledgement for a non-decodable packet in order to solve the various problems stated above.

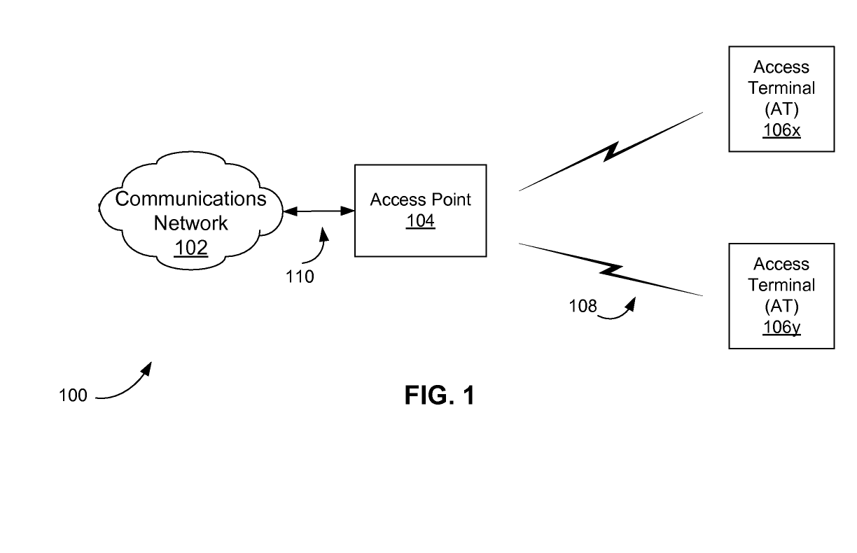

FIG. 1 shows an exemplary high level diagram of a typical wireless communications system 100 that may be used to operate the various aspects disclosed. The various aspects disclosed can be used on any type of communication system that uses a form of HARQ. The communication system could utilize, for example, Universal Mobile Telecommunication System (UMTS), Wide Band CDMA (W-CDMA), Orthogonal Frequency Division Multiplexing (OFDM), Multiple Input Multiple Output (MIMO), or HSDPA. The system used is not limited to wireless communication. A wireless system is described herein for exemplary purposes only in order to facilitate the description of the various aspects disclosed.

The wireless communication system 100 comprises access terminals 106x and 106y that communicate with an access point 104 with an over the air link 108. Access point 104 is connected to a communications network 102 through a network link 110. An access point is generally a fixed station that communicates with user terminals and may also be referred to as a base station, a Node B, or some other terminology as is well known in the art. In some instances, a “master” access terminal may act as an AP. Only two access terminals and one access point are shown for illustration purposes. However, it is well known in the art that a typical wireless communications system has many access points and terminals. The communications network 102 is anything that facilitates end-to-end communication, and could include for example a PSTN/ISDN, MSC, DSL, subscriber databases, WLAN, other access points, POTS, or the Internet.

An AT could include, but is not limited to, any type of terminal device that provides means for wireless communication associated with a wireless communication network. For example, the AT may comprise a laptop, a personal digital assistant (PDA), or mobile phone. Moreover, an AT could function as an AP thereby allowing peer-to-peer and Ad-Hoc type communications.

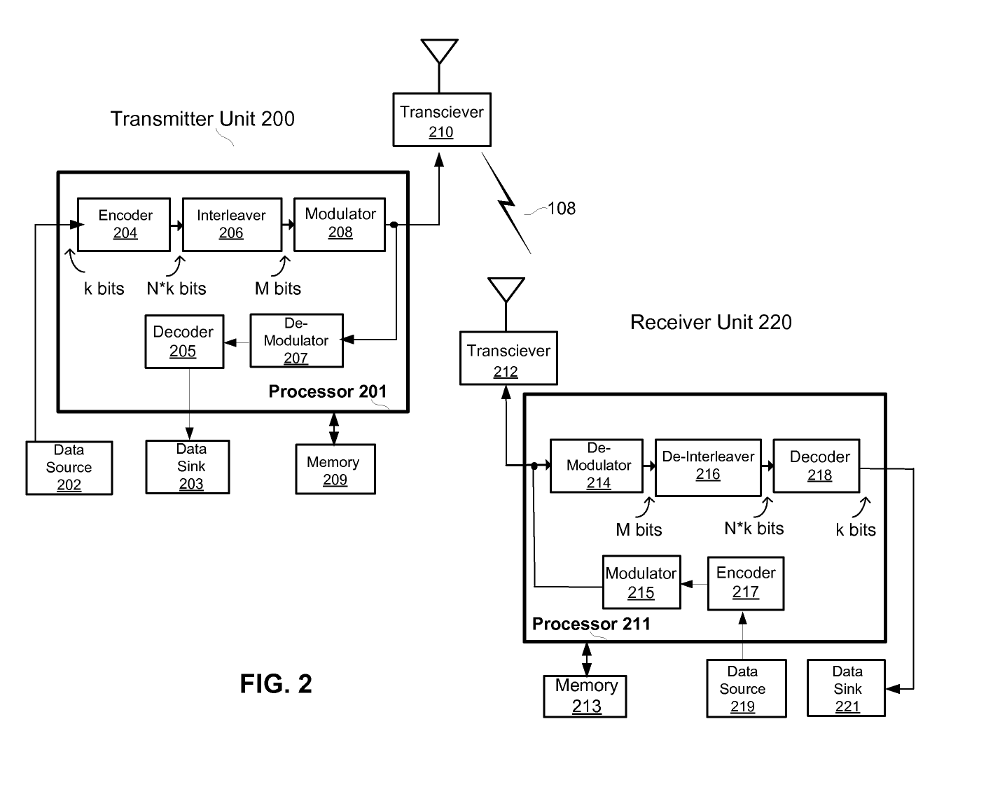

Access point 104 as shown in FIG. 1 may include a transmitter unit 200 and a receiver unit 220 as shown in FIG. 2. Likewise, the AT 106x may include a transmitter unit 200 and a receiver unit 220 as shown in FIG. 2. The transmitter unit 200 and receiver unit 220 communicate with each other utilizing a form of HARQ. At transmitter unit 200, k number of data bits are provided by a data source 202 to an encoder 204. The encoder 204 could be assumed to be a rate 1/3 turbo encoder, but any type of error correction encoding could be used. The encoder 204 would then provide N*k bits (3*k bits in this example) to an interleaver 206. The interleaver may provide rate matching. The interleaver 206 would then select M number of bits to be modulated by a modulator 208. The interleaver 206 determines how many bits are packaged into a sub-block for the HARQ retransmissions. This can be based on many factors, for example, the number of input bits, the rate capacity of the channel, the coding and modulation scheme used, the spectral efficiency, and the targeted number of retransmissions. The modulator 208 could use any type of modulation scheme adaptive or fixed, for example, QPSK or 16QAM as is known in the art. The modulated bits may then be sent over the air on link 108 by a transceiver 210.

Ideally, if no errors are encountered, the modulated bits are received at the receiver unit 220 by a transceiver 212. A demodulator 214 demodulates the modulated bits and sends M number of bits to a de-interleaver 216. The de-interleaver 216 may provide rate matching. The de-interleaver 216 extracts the N*k encoded bits and provides them to a decoder 218. The decoder 218 decodes the N*k bits and provides the original k data bits to a data sink 221. When no errors are detected and the k data bits properly decoded, the receiver unit 220 sends an ACK to the transmitter unit 200 letting the transmitter know that the packet was successfully received. A data source 219 sends bits to an encoder 217. The encoder 217 then provides encoded data bits to a modulator 215. The modulator sends modulated data bits to the transceiver 212. At the transmitter unit 200, the transceiver 210 receives the modulated data bits. The received modulated data bits are then sent to a demodulator 207. The demodulated data bits are decoded by a decoder 205. Decoder 205 sends the decoded data bits to a data sink 203. A processor 201 may include the encoder 204, the interleaver 206, the modulator 208, the demodulator 207, and the decoder 205. The processor 201 may be a single processor, comprise several individual discrete processors, or comprises several individual processors contained on one chip. Also a memory 209 may be coupled to or included inside of the processor 201. Likewise at the receiver unit 220, a processor 211 may include the encoder 217, the de-interleaver 216, the modulator 215, the demodulator 214, and the decoder 218. The processor 211 may be a single processor, comprise several individual discrete processors, or comprises several individual processors contained on one chip. Also a memory 213 may be coupled to or included inside of the processor 211.

In practice, errors due to channel conditions, for example, will occur and cause the packet to be improperly decoded at the receiver unit 220. In many systems that use a form of HARQ, when this happens, the receiver can request a retransmission in the form of a NACK informing the transmitter unit 200 to retransmit packets. The receiver unit 220 could also not send an ACK. In this case, the transmitter unit 200, after a predetermined time was reached during which no ACK was received, would then retransmit the packet. This is typically called synchronous HARQ. There is also another type of HARQ, asynchronous HARQ, in which the retransmission delay is not fixed, but rather the transmitter unit 200 sends a new assignment message for each transmission. Asynchronous HARQ is typically used in HSDPA. In any event, the transmitter unit 200 then retransmits until either an ACK is received or until a predetermined number of retransmissions is exceeded. Typically, HARQ uses large fixed sized retransmission sub-blocks.

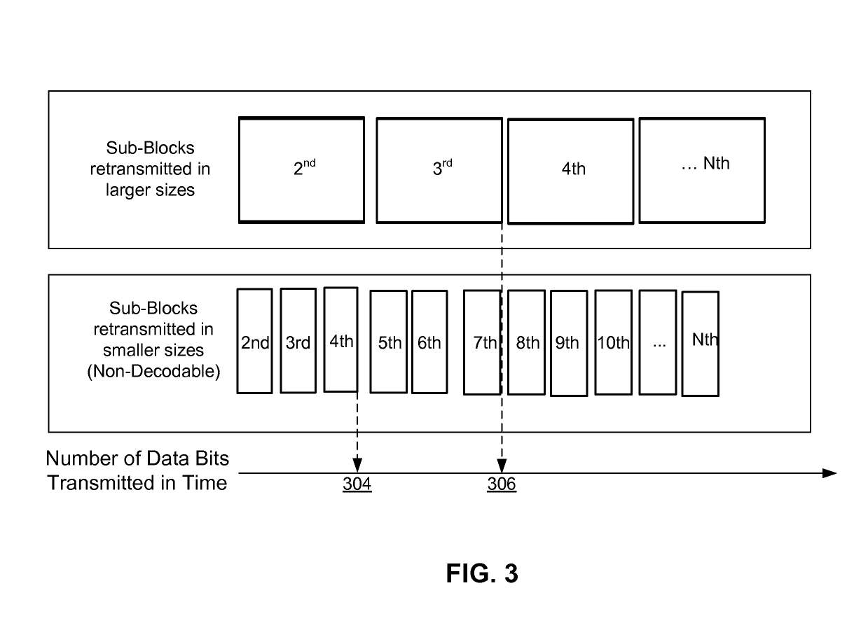

FIG. 3 shows a comparison of HARQ retransmissions that use larger sized sub-blocks and smaller sized sub-blocks. The sub-blocks could be transmitted using transmitter unit 200, and received using receiver unit 220 as shown in FIG. 2. The various aspects disclosed capitalize on a feature of non-decodable packets (smaller sized sub-blocks). A packet is considered “decodable” or “non-decodable” as such: if a packet is transmitted with more than or equal to k pre-encoded number of bits, where k pre-encoded number of bits is the amount of original uncoded bits in a packet as shown in FIG. 2 coming from the data source 202, then the transmitted packet is termed “decodable.” When fewer than k pre-encoded number of bits are transmitted, then the packet is termed “non-decodable.” In FIG. 2 for example, if the transmitter unit 200 sends a packet after encoding (N*k bits) and interleaving (M bits) which contains less than k original pre-encoded bits, then the packet would be considered non-decodable. A more specific example: a native 1/5 rate (N=5) encoder processes a 1000 bit packet from a data source to be transmitted, it produces 5000 encoded bits. Then suppose an interleaver selects M=800 bits for an initial transmission. Since 800<1000, this first transmission would be non-decodable. Thus, in general, the decodablity of the transmitted packet is determined based upon how many encoded bits are sent in the packet. Larger sized sub-blocks are typically “decodable” and smaller sized sub-blocks are typically “non-decodable.”

Even though it may seem advantageous to transmit a larger “decodable” sub-block, there are a few problems that can occur in certain situations. One of the problems is that HARQ typically “rounds up” to the next retransmission number from the actual number of retransmissions the channel can support. So for example, if the actual number of retransmissions the channel could support is two (2), then HARQ will round up to retransmit three (3). This means that the packet could have been decoded in two (2) retransmissions, but the system automatically transmitted three (3). FIG. 3 demonstrates this example. The actual number of retransmissions for the packet to be successfully decoded is located at point 304. However, HARQ will round up to the next higher integer retransmission and retransmit the 3^{rd} sub-block as shown at point 306. Thus, bandwidth is wasted, because of the retransmitted 3^{rd} sub-block. Thus, the spectral efficiency is lowered. The “rounding up” nature of HARQ could also cause some decoding delay. In order to overcome this loss of spectral efficiency and decoding delays, smaller non-decodable packets could be transmitted as shown in FIG. 3. If smaller “non-decodable” sub-blocks are transmitted, then the packet would have been successfully decoded at point 304 after the 4^{th} “non-decodable” sub-block was received without the wasted bandwidth of retransmitting up to point 306. Therefore, even though the packets are transmitted as non-decodable, the IR nature of the transmitted packets enables a receiver to decode them faster with a higher spectral efficiency compared to that of the larger fixed sized packets.

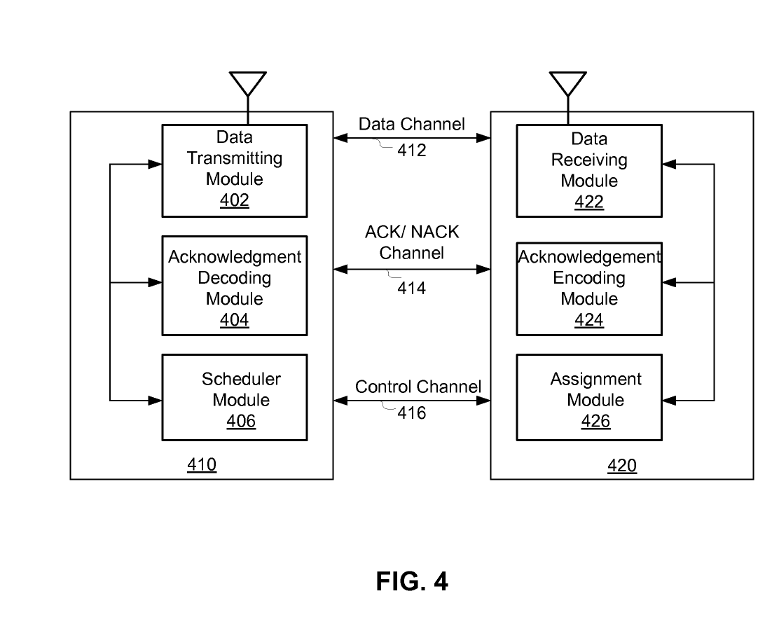

FIG. 4 shows a block diagram of a transmitter 410 and receiver 420 utilizing a form of HARQ in accordance with an embodiment. The transmitter 410 and receiver 420 could transmit and receive smaller “non-decodable” sub-blocks as shown in FIG. 3. The transmitter 410 and receiver 420 communicate with each other using a form of HARQ.

The transmitter 410 sends small non-decodable packets to the intended receiver 420 over a data channel 412. Optionally, the transmitter 410 could select a modulation scheme for each packet and transmit some decodable packets as well as non-decodable packets depending on the modulation scheme chosen. In an aspect, the transmitter 410 could have a data transmitting module 402 that sends the packets to the receiver 420. The receiver 420 could have a data receiving module 422 that receives the packets transmitted from the transmitter. The transmitter 410 knows that the packets will not be decoded until a target number of retransmissions is reached. An optional feature of the disclosed aspect could be for the transmitter 410 to have a scheduler module 406 that transmits a notification, a message, or information on a control channel 416 to inform the receiver 420 of the non-decodable packet transmission mode.

The receiver 420 could optionally have an assignment module 426 that receives this notification and enables the receiver 420 to operate in non-decodable packet mode. Depending on channel conditions or other system parameters, the transmitter 410 could optionally switch between transmitting decodable packet mode and non-decodable packet mode. In any event, once the transmission mode is non-decodable packet mode, the transmitter 410 and receiver 420 can take advantage of this knowledge, independently or both, by suppressing any ACK/NACKs that would normally occur in HARQ over the ACK/NACK channel 414. The transmitter 410 could have an acknowledgement decoding module 404 that ignores, disables the ACK/NACK receiving function, does not look for, or expect an NACK from the receiver 420. Another aspect disclosed is that the transmitter 410 could also choose not to decode any received acknowledgements; could throw away the received NACK. The receiver 420 could have an acknowledgement encoding module 424 that suppresses, disables the transmission of the ACK/NACK, or does not transmit an NACK to the transmitter 410. In an aspect the receiver 420 could send an ACK regardless of what the transmitter decides to do with the ACK/NACKs. These disclosed aspect saves valuable bandwidth in the form of less overhead compared to regular HARQ. The system can also exploit the fact that it does not have to stop-and-wait (SAW) for the NACKs. Thereby, reducing delays, freeing up valuable processing resources, and freeing up channels and other system resources. Also, another advantage of not transmitting or receiving the ACKs/NACKs is that the risk of an erroneously detected ACK/NACK is removed. Incorrectly detected ACK/NACK can result in the loss of a data block and cause serious transmission problems. The disclosed aspects, by suppressing ACKs/NACKs removes this risk from the system.

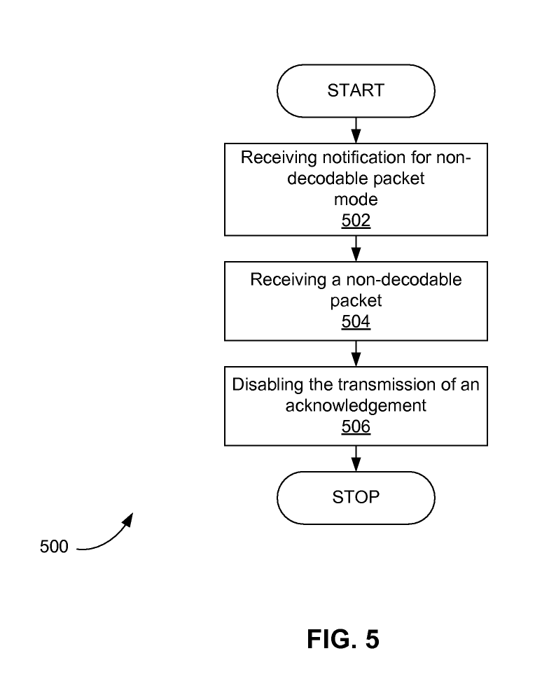

FIG. 5 shows a method 500 for a receiver using a form of HARQ with an aspect of the disclosure. Receiver 420 as shown in FIG. 4 could be used to perform the method 500 of FIG. 5. First, at step 502, a notification for non-decodable packet mode is received. Next, at step 504, a non-decodable packet is received. Finally, at step 506, the transmission of the acknowledgment is disabled and not transmitted. The process could be repeated until a target number of retransmissions is reached.

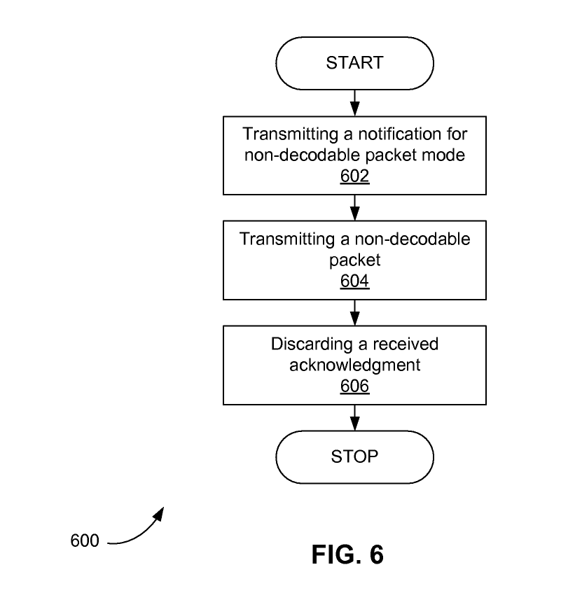

FIG. 6 shows a method 600 for a transmitter using a form of HARQ with an aspect of the disclosure. Transmitter 410 as shown in FIG. 4 could be used to perform the method 600 of FIG. 6. First, at step 602, a notification for non-decodable packet mode is transmitted. Then, at step 604, a non-decodable packet is transmitted. Finally, at step 606, the received acknowledgment is discarded, not decoded, or looked for. The process could be repeated until a target number of retransmissions is reached.

Those skilled in the art would further appreciate that the various illustrative logical blocks, modules, and steps described in connection with the aspects disclosed herein may be implemented as hardware, software, firmware, or any combination thereof and hardware implementation may be digital, analog or both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

The various illustrative logical blocks, and modules described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, an integrated circuit, one or more microprocessors in conjunction with a DSP core, or any other such configuration.

An exemplary storage medium is coupled to the processor such the processor could read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The steps or functions of a method or algorithm described in connection with the aspects disclosed herein may be embodied directly in hardware, in software executed by a processor, or in a combination of the two. The steps or functions could be interchanged without departing from the scope of the aspects.

If the steps or functions are implemented in software, the steps or functions may be stored on or transmitted over as one or more instructions of code on a computer-readable medium. Computer-readable media includes both computer storage media and communication media including any media that facilitates transfer of a computer program from one place to another. A storage media may be any available media that could be assessed by a general purpose or special purpose computer. By way of example, and not limitation, such computer-readable media could comprise RAM, flash memory, ROM, EPROM, EEPROM, registers, hard disk, a removable disk, a CD-ROM, optical disk storage, magnetic disk storage, magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source, using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically. A computer program product would also indicate materials to package the CD or software medium therein. Combinations of the above should also be included within the scope of computer-readable media.

The previous description of the certain aspects is provided to enable any person skilled in the art to make or use the invention. Various modifications to these aspects will be readily apparent to those skilled in the art, and the generic principles defined herein may be applied to other aspects without departing from the scope of this disclosure. Thus, this disclosure is not intended to be limited to the aspects shown herein but is to be accorded the widest scope consistent with the principles and novel features disclosed herein.

What is claimed is:

1. A method for receiving a non-decodable packet, comprising:
receiving a non-decodable packet; and
suppressing the transmission of an acknowledgment of the received non-decodable packet.

2. The method of claim 1, further comprising:
receiving on a control channel information indicating a non-decodable packet communication mode, wherein the suppressing the transmission of the acknowledgment is activated based upon receiving the non-decodable packet communication mode.

3. The method of claim 1, wherein the suppressing the transmission of the acknowledgement comprises:
disabling the transmission of the acknowledgement.

4. The method of claim 1, wherein the suppressed acknowledgement is a NACK.

5. The method of claim 1, wherein a non-decodable packet is a packet in which less than k number of encoded bits are transmitted, wherein k is the number of pre-encoded bits in the packet prior to encoding.

6. A method for transmitting a non-decodable packet, comprising:
transmitting a non-decodable packet; and
suppressing an acknowledgment of the transmitted non-decodable packet.

7. The method of claim 6, further comprising:
transmitting on a control channel information that informs a receiver of a non-decodable packet communication mode.

8. The method of claim 6, wherein the suppressing the acknowledgment of the transmitted non-decodable packet comprises:
discarding the acknowledgment of the transmitted non-decodable packet.

9. The method of claim 6, wherein the suppressed acknowledgement is a NACK.

10. The method of claim 6, further comprising:
transmitting a predetermined number of non-decodable packets.

11. The method of claim 6, wherein the suppressing the acknowledgment of the transmitted non-decodable packet comprises:
declining to decode the acknowledgment whether the acknowledgment is received or not.

12. The method of claim 6, further comprising:
selecting a modulation scheme for each transmitted packet; and
transmitting a non-decodable packet for some of the transmissions based upon the selected modulation scheme.

13. The method of claim 6, wherein the transmitted non-decodable packet is transmitted utilizing MIMO.

14. An apparatus for receiving a non-decodable packet in a communication system that employs Hybrid Automatic Repeat Request (HARQ), comprising:
means for receiving a non-decodable packet; and
means for disabling the transmission of an acknowledgment of the received non-decodable packet.

15. The apparatus of claim 14, further comprising:
means for receiving on a control channel information that informs the apparatus of a non-decodable packet mode, wherein the means for disabling the transmission of the acknowledgment is activated based upon receiving the non-decodable packet communication mode.

16. The apparatus of claim 14, wherein the acknowledgement is a NACK.

17. The apparatus of claim 14, wherein the received non-decodable packet is received utilizing MIMO.

18. An apparatus for transmitting a non-decodable packet in a communication system that employs Hybrid Automatic Repeat Request (HARQ), comprising:
means for transmitting a non-decodable packet; and
means for suppressing an acknowledgment of the transmitted non-decodable packet.

19. The apparatus of claim 18, further comprising:
means for transmitting on a control channel information that informs a receiver of a non-decodable packet mode.

20. The apparatus of claim 18, wherein the acknowledgement is a NACK.

21. The apparatus of claim 18, where in the transmitted non-decodable packet is transmitted utilizing MIMO.

22. The apparatus of claim 18, further comprising:
means for transmitting a predetermined number of non-decodable packets.

23. The apparatus of claim 18, wherein the means for suppressing the acknowledgment of the transmitted non-decodable packet further comprises:
means for declining to decode the acknowledgment whether the acknowledgment is received or not.

24. The apparatus of claim 18, further comprising:
means for selecting a modulation scheme for each transmitted packet; and
means for transmitting a non-decodable packet for some of the transmissions based upon the selected modulation scheme.

25. An integrated circuit for receiving a non-decodable packet, comprising:
a processor operable to receive on a control channel information that informs a receiver of a non-decodable packet transmission mode, to receive a non-decodable packet, and disable the transmission of an acknowledgment of the received non-decodable packet in response to the non-decodable packet transmission mode; and
a memory associated with the processor.

26. The integrated circuit of claim 25, wherein the acknowledgement is a NACK.

27. The integrated circuit of claim 25, wherein the received non-decodable packet is received utilizing MIMO and Hybrid Automatic Repeat Request (HARQ).

28. An integrated circuit for transmitting a non-decodable packet, comprising:
a processor operable to transmit on a control channel information that informs a receiver of a non-decodable packet transmission mode, to transmit a non-decodable packet, and to discard an acknowledgment of the transmitted non-decodable packet; and
a memory associated with the processor.

29. The integrated circuit of claim 28, wherein the acknowledgement is a NACK.

30. The integrated circuit of claim 28, where in the transmitted non-decodable packet is transmitted utilizing MIMO and Hybrid Automatic Repeat Request (HARQ).

31. The integrated circuit of claim 28, wherein the processor is further operable to
transmit a predetermined number of non-decodable packets.

32. The integrated circuit of claim 28, wherein the processor is further operable to:
decline to decode the acknowledgment whether the acknowledgment is received or not.

33. The integrated circuit of claim 28, wherein the processor is further operable to:
select a modulation scheme for each transmitted packet; and
transmit a non-decodable packet for some of the transmissions based upon the selected modulation scheme.

34. An apparatus for receiving a non-decodable packet, comprising:
an assignment module that enables the apparatus to receive on a control channel information that informs the apparatus of a non-decodable packet communication mode;
a data receiving module that enables the apparatus to receive a non-decodable packet; and
an acknowledgement encoding module that enables the apparatus to suppress the transmission of a NACK for the received non-decodable packet based upon the non-decodable packet communication mode.

35. The apparatus of claim 34, wherein the apparatus is configured to operate with a MIMO and Hybrid Automatic Repeat Request (HARQ) scheme.

36. An apparatus for transmitting a non-decodable packet, comprising:
a scheduler module that enables the apparatus to transmit on a control channel information that informs a receiver of a non-decodable packet communication mode;
a data transmitting module that enables the apparatus to transmit a non-decodable packet; and
an acknowledgement decoding module that enables the apparatus to discard a NACK for the transmitted non-decodable packet.

37. The apparatus of claim 36, wherein the apparatus is configured to operate with a MIMO and Hybrid Automatic Repeat Request (HARQ) scheme.

38. The apparatus of claim 36, wherein the scheduler module further enables the apparatus to transmit a predetermined number of non-decodable packets.

39. The apparatus of claim 36, wherein the acknowledgement decoding module further enables the apparatus to decline to decode the acknowledgment whether the acknowledgment is received or not.

40. The apparatus of claim 36, wherein the data transmitting module further enables the apparatus to select a modulation scheme for each transmitted packet; and
transmit a non-decodable packet for some of the transmissions based upon the selected modulation scheme.

41. A computer program product, comprising:
computer-readable medium comprising:
code for causing a computer to receive on a control channel information that informs a receiver of a non-decodable packet transmission mode;
code for causing a computer to receive a non-decodable packet; and
code for causing a computer to disable the transmission of an acknowledgment of the received non-decodable packet in response to the non-decodable packet transmission mode.

42. A computer program product, comprising:
computer-readable medium comprising:
code for causing a computer to transmit on a control channel information that informs a receiver of a non-decodable packet transmission mode;
code for causing a computer to transmit a non-decodable packet; and
code for causing a computer to discard an acknowledgment of the transmitted non-decodable packet.
